(19) United States
(12) Patent Application Publication
(10) Pub. No.: US 2023/0153721 A1
(43) Pub. Date: May 18, 2023

(54) Chemical Ordering Operator App

(71) Applicant: WashTec Holding GmbH, Augsburg (DE)

(72) Inventors: Andreas Sattler, Muenchen (DE); Simon Wolfinger, Ederheim (DE); Michael Schreiner, Augsburg (DE)

(73) Assignee: WashTec Holding GmbH, Augsburg (DE)

(21) Appl. No.: 18/055,800

(22) Filed: Nov. 15, 2022

(30) Foreign Application Priority Data
Nov. 15, 2021 (WO) 21208281.2

(51) Int. Cl. G06Q 10/0631; G01F 23/80

(52) U.S. Cl. CPC G06Q 10/06315; G01F 23/802

(57) ABSTRACT

Predicting a refill requirement for wash substances for performing a vehicle wash using a wash system for the car wash for performing the vehicle washing, wherein the control module is for providing a refill data set for predicting a refill requirement for washing substances. The control module comprises at least one measuring device for detecting current fill level data for each of the washing substances and a data link between the at least one measuring device and the control module for transmitting the detected fill level data to the control module. The control module is designed to perform a prediction function for calculating a refill data set, in which a prediction of the refill requirement is encoded, based on planning data, which represent planned vehicle washes at the washing system taking into account washing-substance-specific consumption data.

The present invention is in the field of washing systems for means of transport. In particular, the invention relates to a method, system, control module and computer program for predicting replenishment or refill requirements of resources needed for a transport means washing operation, such as washing substances.

Means of transport, such as motor vehicles, trucks and/or buses, are exposed to environmental influences. These environmental influences can be of natural or anthropogenic origin and lead to soiling of the means of transport. From the point of view of safety and aesthetics, it is advisable to clean or wash the means of transport regularly. Washing facilities offer the necessary washing services. There, means of transport can be washed fully or semi-automatically or manually. The washing process requires resources, especially washing substances, in sufficient quantities to achieve the desired cleaning result. The consumption of the washing substances can be influenced by various factors and technical conditions of the washing system and is therefore usually difficult to predict with systems known in the prior art. However, a timely and realistic prediction of a washing substance consumption is important for the operator of the washing system, since the quality of the wash cannot be ensured if cleaning resources are lacking.

On this basis, the present application is based on the task of creating an approach that provides the operators of a car wash with the prediction of a refill requirement for the respective washing substances needed on the car wash.

This task is solved by the enclosed patent claims, in particular by a method, a control module, a system for providing a refill data set for predicting a refill requirement for washing substances and by a computer program for executing the method for predicting a refill requirement. Advantageous embodiments and further embodiments of the invention can be found in the subclaims and in the following description.

According to a first aspect, the object is solved by a method for predicting a refill requirement for washing substances for performing a vehicle wash by means of a washing system. The method comprises the following method steps:

Reading in of currently recorded fill level data for each of the washing substances by means of a measuring device, in each case, the reading in being carried out via a reading interface;

On a control module: Performing a prediction function to calculate a refill data set, in which a prediction of the refill requirement is encoded, based on planning data representing scheduled vehicle washes at the car wash, taking into account wash substance-specific consumption data and the acquired fill level data; and

Output the calculated refill data set to predict a wash substance specific refill requirement on an output device.

The need for refilling can thus be detected and reported in advance and in good time by the computer-implemented process in the sense of a predictive supply report in relation to the technical resources of the vehicle washing system. This ensures that sufficient washing substances are always available and that the washing process can be carried out at all or properly and does not have to be interrupted in order to refill washing substances.

The terminology of the invention is explained in more detail below.

The process is computer-implemented. The control module is used to process different data. A refill data record is calculated. Fill level data and optionally consumption data and/or planning data are processed algorithmically. The computer implementation can be realized in software and/or in hardware.

The fill level data is an electronic data record that represents the current fill level in a supply area or part of it. The fill level data is recorded by a measuring device and read in via a read-in interface. The read-in interface can be a local area network (e.g. radio) or a WAN (wide area network, e.g. the Internet). The local network can be wired or wireless.

The refill data record is an electronic data record in which a (future) refill requirement for a wash substance is encoded. The refill data record is calculated algorithmically by means of a prediction function. The prediction function processes the acquired fill level data and optionally planning data and/or consumption data. The calculated refill data set may be output to an output device. Cumulatively or alternatively, the calculated refill data set can be used to automatically trigger an ordering process via a connected gateway node for data exchange with external and/or remote (i.e., not located in the area of the washing system) computing units (e.g., by means of a WAN, in particular providing Internet access) and, in particular, with a computing unit of a supplier of washing substances. In an advantageous further development, the automatic ordering process encoded in an order data record can be output again for verification, e.g. on the output device, in order to receive a verification signal in response to which the ordering process is then automatically triggered.

The term “planning data” is to be understood as an electronic data set that encodes properties of washes planned at the car wash. The properties are coded in parameters and can be e.g. a number, a type (wash program), vehicle type of scheduled washes. The scheduling data may include statistical values (e.g., averages) recorded in the past and, representing the usual demand for wash substance over a period of time and/or as a function of a location of the wash facility. The planning data can also include the consumption, specific to a wash substance as a further influencing variable for the prediction function.

The term “consumption data” is to be understood as an electronic data record that indicates the respective consumption of the individual washing substance. Furthermore, consumption data for one washing substance at a time can be calculated from a recorded dosing setting of a digital pump that is used to provide the respective washing substance.

The term “digital pump” in this context means a pump with an internal or connected electronic unit that converts analog signals via an AD converter and can process digital signals and/or send them to other electronic components. The digital pump thus also includes those metering pumps where only the stroke is measured directly or indirectly, but the remaining part of the pump is analog. This can be realized, for example, by an air flow measurement on a pneumatic dosing pump which has a manual stroke adjustment.

To calculate the consumption data, the consumption of the individual washing substances can be determined separately and dedicatedly or individually for each washing substance. This can be done via known metering settings of a digital pump and/or by automatically detecting the fill level in the machine canister via fill level sensors. The consumption data can be determined from the read-in or recorded fill level data in an electronic unit using an automatic method. The determined consumption data can be allocated to the number of washes performed. This can be done, for example, using the switch-on time of the spray arc and metering pump of the washing system. The consumption per wash varies, depending on the wash program, the settings of devices for the washing system (e.g. of the metering pump) and/or the vehicle size and/or the degree of soiling.

In order to determine a consumption that is independent of the wash program and/or vehicle type and/or the degree of soiling, in a first procedure, average values for the consumption can be formed in order to eliminate the vehicle influence and/or the other influences mentioned. Subsequently, the predicted consumptions can be extrapolated based on historical washes. In a second method, the vehicle type of vehicles washed and/or to be washed can be calculated based on a generated feature model. Input data (e.g., vehicle type, year of manufacture) is entered prior to the wash, which is then used to determine a vehicle type. Furthermore, a data structure can be stored in a memory that stores average consumption data for each vehicle type. These can be taken into account for calculating the consumption data.

The term “washing substances” is to be understood in the sense of substances, in particular chemicals or natural substances, which can be used in the context of vehicle washing and/or water treatment for vehicle washing with a vehicle washing system (in short: “washing system”) and can be provided, for example, in corresponding storage containers. Furthermore, “washing substances” may be understood to mean a single washing substance or a plurality of separate washing substances. If a plurality of washing substances are present, they may be mixed in a certain ratio prior to the washing process. Otherwise, or in addition, the plurality of washing substances can be used consecutively within a washing process, for example for different sub-operations of the washing process.

The washing substances can be in liquid and/or dry and/or vaporized form. The washing substances may already be ready for use. The washing substances may be in concentrated or highly concentrated form and/or may be mixed with other substances, for example water, in a predetermined ratio prior to use. The predetermined ratio may be varied in some applications depending on vehicle characteristics.

A car wash is a device that provides washing devices or aggregates or cleaning arrangements for vehicles. The cleaning arrangements clean the vehicle with the aid and use of the washing substances by direct intervention of the cleaning arrangement (wiping, cleaning, polishing, scrubbing) or indirectly (application of liquids, vapors, compressed air). The car wash can be designed as a gantry car wash, car wash line and/or self-service car wash box (self-service). These wash vehicles fully automatically, semi-automatically, or provide the framework for manual cleaning by a user. Car washes can denote both devices that wash a single car and devices that wash multiple cars in parallel (car wash line).

Car washes can offer different programs, such as a full wash or a partial wash of a specific part of the vehicle, or programs with different intensity and/or duration of the wash (for example, quick wash, intensive wash, with/or without a care program). Programs can also vary seasonally. In winter, for example, a program can be offered that specifically cleans the vehicle's underbody because of possible contamination from road salt. In summer, a program can be offered that focuses in particular on contamination due to insects. The washing substances and their concentration can be adapted by the car wash to the corresponding program (washing substance-specific consumption data). In particular, historical consumption data for the various programs can be made available in the control module for this purpose.

The method can be arranged in the washing system and/or in a control module of the washing system, for example in a programmable logic controller (PLC) in a computing unit. The method can be executed in a distributed manner. For example, part of the method may be executed on an operator app in data exchange with the control module of the car wash. Alternatively or cumulatively, the control module may be provided as a mobile app, for example to output the calculated refill data set on a mobile device. Alternatively or cumulatively, the control module may be implemented on the car wash and the output is performed via a wireless communication interface on the output device (e.g., mobile device). Also, the process can be executed in a cloud. Especially in a car wash operation with multiple individual car washes cleaning multiple vehicles in parallel, the procedure can be executed on a single central processing unit. The procedure can be made available in a persistent memory (e.g. flash memory) so that it can continue to be executed after a power failure or other interruption.

The measuring equipment can transmit currently recorded fill level data to the read-in interface via a bit-serial or parallel data bus. In this context, “currently recorded fill level data” means that the fill level of the washing substances is transmitted to the read-in interface in real time, i.e. without any significant delay. The fill level data is state data, which in one embodiment of the invention is continuously recorded. It is also conceivable that the fill level data is only acquired at certain times, for example during the daily start-up of the washing system. The read-in interface can store the currently acquired level data in a peristent memory (flash memory) or non-peristent memory (RAM) for further processing. The read-in of the acquired fill level data via the read-in interface can be performed according to a PUSH or POLL protocol, in which the control module specifically queries the acquired levels from the sensors of all or selected washing substances (POLLING) or in which the fill level sensors send changes in “their” measured values to the control module (PUSH). The latter has the advantage that the fill level data are only transmitted when values have actually changed. The sensor can send the data immediately after a value change and therefore does not need any additional buffers. In contrast, the POLLING model has the advantage of the explicitly serial and determinable behavior of polling programming and that it is a very fast polling of, for example, a hardware connection, which assumes the desired state within microseconds. Alternatively, a PULL model can be applied, where the control module fetches the next information itself when it needs it. The advantage is that the control module only fetches or requests the fill level data when it falls within a predefined time frame. Data in fixed time steps is easier to handle than event-based data handling. Another advantage is the easier detection of errors that occur in the data acquisition/data transmission. For example, the control module can slow down the data transmission in an overload situation.

In one embodiment of the invention, the measuring device is an arrangement that directly or indirectly measures the volume of the washing substance still present or the volume of the washing substance already used. E.g., via a pressure measuring probe when the density of the substance to be measured is known, or via ultrasonic sensors or floats or capacitive, the filling level in a container of known geometry can provide information about the filling volume of the chemical product. Alternatively, the weight of the container with contents can be measured, which can be used to calculate the volume of the chemical if the density of the chemical and the empty weight of the container are known. If the container filling volume is known, the residual quantity of the washing substance (in the container) can also be determined via volumetrically measuring flow sensors, e.g. oval wheel meters, and the known pump volume of a metering pump and via the measured withdrawal volume and difference formation.

In a particularly preferred embodiment of the invention, the measuring device is a level sensor that detects the fill level of the washing substance in a container. The level sensor can be based on different common physical principles, such as mechanical level measurement, conductivity measurement, capacitive measurement, optical measurement, ultrasound and/or radar.

Mechanical methods include vibration sensors, rotary vane switches, floats combined with a displacement transducer (e.g. potentiometer), electromechanical plumb bob systems, level probes or the hydrostatic level gauge.

The conductivity measurement assigns a conductivity to the washing substance that deviates from the other medium in the container (e.g. air) and determines the fill level on this basis. For this purpose, the conductivity of the washing substance and/or the air is measured and the corresponding fill level is inferred. In particular, the electrical conductivity and/or the thermal conductivity of the washing substance and/or the other medium (e.g. air) can be measured.

In capacitive measurement, the change in the dielectric constant between two electrodes is recorded and, based on this, the fill level of the washing substance is determined by the measuring device. If the measuring device performs an optical measurement, light is emitted (e.g. by an infrared LED) and the absorption and/or reflection behavior of the washing substance is recorded at a receiver and the filling level of the washing substance is determined. Cumulatively or alternatively, the measuring device can emit ultrasonic waves from a corresponding transmitter and record their reflection by means of a corresponding sensor, which provides information about the transit time of the ultrasonic waves to the surface of the washing substance. On the basis of this, the fill level of the washing substance can be inferred. Measurement with radar, which can be carried out by the measuring device, for example, is also based on this transmitter-receiver principle.

Alternatively or in addition, the measuring device can be image-based and comprise or connect to a camera image evaluation. The camera image evaluation can determine the fill level of the washing substances in a container via an image recognition algorithm. The image recognition algorithm may be trained using a machine learning method. The machine learning method may be implemented in a supervised or unsupervised manner.

Furthermore, the weight of the containers with the remaining washing substances can be measured (e.g. by a scale) and, taking into account the density of the respective washing substance and the dimensions of the container, the fill level in the container can be concluded. Furthermore, a float or a marker in connection with a transparent container in combination with the camera image evaluation described above can be considered.

Alternatively or in addition, the washing system can be equipped with a digital pump connected to the containers with the washing substances. The digital pump can, for example, be designed with an electric metering pump that records the volume of washing substances supplied at runtime and the rate of supply from the measuring device, from which the remaining fill level can be calculated by a subtraction process. Alternatively, the digital pump can be designed with a simple pneumatic piston pump that completely discharges a fixed volume of wash substance, or at least one that can be set in advance. The digital pump records the number of its doses in order to be able to calculate the remaining fill level by means of a subtraction process.

The prediction function for calculating a refill data set can calculate a prediction of how many vehicle washes are possible with the currently available washing substances, taking into account a “default” average value, which indicates what quantity of each washing substance is required for a usual vehicle wash, and the fill level data of the corresponding washing substance. The prediction function can also take into account planning data and consumption data specific to the washing substance.

In a preferred embodiment of the invention, the refill requirement, which is encoded in the calculated refill data record and which is specific for one of the washing substances in each case, is structured by means of a configurable data structure so that it can be displayed for how many of the planned washes and/or for which vehicle types (which are stored in a database assigned to specific washing programs) the corresponding washing substance is still available in sufficient quantity. For at least one parameter (type of washing substance, time horizon, etc.), at least one threshold value can be configured for the output of the refill requirement in the form of a message, which defines the conditions under which the message is output (e.g. a low threshold value can be configured for an “important” washing substance and/or likewise for a refill requirement lying far in the future). Here a prioritization of the message output can be done. The closer the refill requirement is and thus the more urgent it is, the higher the priority of the output on the output device (cyclic display of the message with a short cycle time and/or output on additional devices and/or output via additional channels, e.g. audible and/or LED). Cumulatively or alternatively, a limit value can be defined which is already expected to require refilling at least in the medium term. The refill requirement can be coded in different units. For example, it can be coded in how many days the washing substances must be refilled, or how many vehicle washes can still be carried out with the stock.

The output device can be a terminal directly at the car wash or a mobile terminal that exchanges data with the car wash. The output device can also comprise several devices, so that the calculated refill data record can be output simultaneously at several locations. Alternatively or additionally, the calculated refill data set can be output at a central location, such as the monitoring device of a car wash with several individual car washes. The output device may generate signals of different types. For example, the output device may output the calculated refill data set by signals that can be perceived visually, acoustically, and/or haptically (e.g., vibration). The output device may vary the intensity and temporal spacing of the signals. The output device may further communicate with, for example, a distributor that distributes the wash substances to register a refill request and/or order the corresponding wash substance for which a refill request has been calculated.

Furthermore, the measuring device can include an identification device that is set up to identify the washing substance. Preferably, the identification device can be implemented as an application (app) that is installed on a mobile terminal. Furthermore, a scanner may be implemented on the mobile terminal for scanning a digital code to identify the washing substance via the code identifying the washing substance applied to the storage container.

Preferably, the identification device is a scanner that scans a digital code attached to the container for the washing substance. As an alternative to a scanner, an app can be used via which a user enters the manually recorded fill levels via a so-called “human-machine interface” (HMI). Via the HMI, a user can identify the container of washing substance by voice input, key combination and/or click.

In a further preferred embodiment of the invention, the acquisition of the fill level data comprises a direct acquisition of the fill levels of storage containers directly at the washing system and an indirect acquisition of the fill levels in a storage area of the washing system. In particular, this may involve a storage area in a technical room at or near the washing system. Here, the “indirect sensing” (or indirect acquisition may refer to the fact that in a memory (for example, the persistent memory mentioned above) the number of containers in stock in a technical room and their volume are stored and these are used when executing the prediction function.

The washing system can have sensors that determine vehicle properties via a corresponding evaluation and adapt the washing process to the vehicle properties. The vehicle properties can relate to constant and/or time-varying properties, such as vehicle dimensions, vehicle type, body design (for example convertible), degree of soiling and/or type of soiling.

Preferably, consumption is determined on a location-specific basis, i.e., as a function of the car wash, its settings and/or the wash program, as well as the vehicle washes sold per time increment. The distribution of the vehicle washes performed is strongly time-dependent. The distribution is further dependent on the location and/or the parameters of the purchased vehicle washes (extensive, high quality program or fast program). The distribution of vehicle washes depends on the location of the washing facility. If it is a facility on a federal highway or if the facility is located near a shopping mall, this leads to different numbers of vehicle washes or to different frequencies of the car wash. For example, there may be an accumulation of vehicle washes on a main road, especially during the early evening hours (i.e. after typical working hours), while a car wash at a shopping center may be more frequented on a Saturday, for example, than during the early evening hours.

The purchased and/or scheduled washes can also be weather and season dependent. For this purpose, the forecasting method for predicting a refill requirement may provide access to a database in which the respective weather and seasonal conditions are stored per unit of time. The database may provide historical values and future ones, as far as calculable. The above-described evaluation of the executed and/or scheduled washes under correlation with weather and/or seasonal data can trigger a further benchmarking calculation to show the operator when which consumption data occur and/or in which time period, which wash programs are executed.

In a preferred embodiment of the invention, consumption data from each wash may be aggregated. Alternatively or cumulatively, average consumption values can be determined from the recorded consumption data. Advantageously, the determined average consumption values are independent of the respective settings of washing units of the washing system (e.g., setting of the metering pump) and/or of the vehicle type. The average values can be determined using two methods. First, if the dosing pump is accurate, the volume of individual washes can be recorded and then added up and divided by the number of washes. Secondly (if, for example, a sufficiently accurate pump is not installed), the average values can be determined from the fill level data measured at intervals, e.g. the fill level data can be measured at the beginning and then again after a preconfigured number of washes, e.g. after 100 washes. The fill volume difference/100 (or divided by the preconfigured number) is then the average consumption determined.

Further, the consumption data can be calculated specifically for each car wash and/or the consumption data can be correlated with car wash-specific historical consumption data and/or with weather data and/or with holiday data.

Furthermore, the control module can match the calculated refill data set, which represents a refill requirement of a respective washing substance for the washing system, with a reference value determined from predictions and/or historical data of the washing system, in particular by means of averaging. This has the advantage that, in a further preferred embodiment of the invention, the method implemented (e.g. in the control module) is self-optimizing in that the calculated prediction data is stored and later compared with the real measured data in order to continuously improve the prediction algorithm.

Preferably, the calculated and output refill data set for predicting a refill requirement can comprise an ascending alert depending on a time interval to the (imminent) refill requirement. Thereby, the ascending alerting can be designed in such a way that with decreasing supply, the priority of the alert message is increased and this is conveyed, for example, with a shorter time interval of an output and/or output on different devices and/or via different channels.

Furthermore, the intensity of the alarm message can also be intensified, for example by louder acoustic and/or stronger optical signals.

The procedure can be carried out continuously in the background of the car wash. Alternatively, or in addition, the procedure can also be carried out only on special occasions (during the daily start-up of the washing system or during a daily check-up).

The solution of the object was described above on the basis of the method. Features, advantages or alternative embodiments mentioned therein are likewise to be applied to the other claimed subject matters and vice versa. In other words, the subject matter claims (which are directed, for example, to a control module or a system or to a computer program) may also be further formed with the features described or claimed in connection with the method and vice versa. In this case, the corresponding functional features of the method are formed by corresponding apparatus modules, in particular by hardware modules or microprocessor modules, of the system or the product, and vice versa. The advantageous embodiments of the invention of the method described above may also be implemented in the control module or in the system. The advantageous embodiment and further features described in connection with the method are not repeated separately here.

According to a second aspect, the problem according to the invention is solved by a control module for a car wash for performing a vehicle wash, wherein the control module is configurated for providing a refill data set for predicting a refill requirement for washing substances. The control module comprises:

At least one measuring device for recording current fill level data for each of the washing substances;

A data link between the at least one measuring device and the control module for transmitting the detected fill level data to the control module;

wherein the control module is designed to perform a prediction function for calculating a refill data set, in which a prediction of the refill requirement is encoded, on the basis of planning data representing scheduled vehicle washes at the car wash, taking into account washing substance-specific consumption data and the detected fill level data;

With an output device designed to output the refill data set calculated by the control module to predict a wash substance specific refill requirement.

According to a third aspect, the problem according to the invention is solved by a system for providing a refill data set for predicting a refill requirement for washing substances for a vehicle wash. The system includes above-described control model and a washing system for performing the vehicle washing.

According to a fourth aspect, the object according to the invention is solved by a computer program. The computer program is loadable into a memory unit of a computing unit and includes program code portions for causing the computing unit to execute the method for predicting a refill requirement for washing substances for a washing system according to the method described above when the computer program is executed in the computing unit.

In the following detailed description of figures, non-limiting embodiments with their features and further advantages are discussed on the basis of the drawings.

### BRIEF DESCRIPTION OF THE FIGURES

FIG. 1 shows a schematic representation of an example of a control module for a washing system according to the invention;

FIG. 2 shows a schematic diagram of a first example of a system according to the invention with a control module and a washing system;

FIG. 3 shows a schematic diagram of a second example of a system according to the invention with a control module and a washing system;

FIG. 4 is an example of a flow chart for a method according to the invention for predicting a refill requirement for washing substances;

FIG. 5 is a second example of a flow chart for a method according to the invention for predicting a refill requirement for washing substances;

FIG. 6 is another example of a flow chart for a method according to the invention for predicting a refill requirement for washing substances.

### DETAILED DESCRIPTION OF THE FIGURES

In the following, the invention is described in more detail by means of embodiment examples in connection with the figures.

The scope of protection of the present invention is given by the claims and is not limited by the features explained in the description or shown in the figures.

The present invention relates to a method, control module, system, and computer program for predicting a refill requirement for washing substances for performing a vehicle wash by means of a washing system

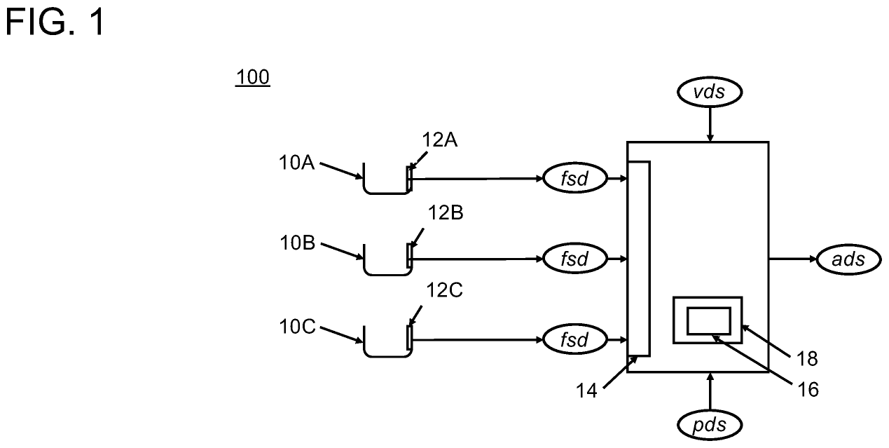

FIG. 1 shows a schematic representation of an example of a control module 100 for a washing system according to the invention. In contrast to FIG. 1, the control module 100 can also be configurated as a distributed system. The control module 100 comprises a read-in interface 14. The fill level data fsd is read in via the read-in interface 14. The fill level data fsd are provided by the measuring device 12A, 12B, 12C at the read-in interface 14 of the control module 100. The measuring device 12A, 12B, 12C use the fill level data fsd to detect the current fill level of the containers 10A, 10B, 100. The containers 10A, 10B, 100 contain washing substances. The containers 10A, 10B, 100 provide various washing substances, the fill level of which is monitored by the measuring devices 12A, 12B, 12C continuously or at specific times. Although the measuring devices 12A, 12B, 12C are shown here as individual measuring devices, a central measuring device can also detect the fill level of the respective containers. Furthermore, the control module 100 can read in consumption data vds and planning data planning data pds via interfaces (not shown).

In a possible embodiment, the read-in interface 14 can be implemented, for example, via a proprietary CAN protocol (CAN: Controller Area Network) on a CAN bus. The sensors are fill level sensors with a reed chain, which are evaluated by evaluation electronics, which can preferably be arranged in the dosing pump. Alternatively, a decentralized 10 card with evaluation electronics can be used instead of a dosing pump, which then also converts the evaluation result to the CAN bus. The CAN bus or the CAN bus system can be designed with a data transmission speed of up to 1 Mbit/s for serial data exchange between sensors and/or control units. Depending on the version of the bus system, each of the networked devices (control module, dosing pump with an electronic unit and/or sensors, etc.) has a CAN interface (bus controller+bus transceiver) to be connected to the bus. The device can first check whether the data packets sent via the bus are of significance for the device. This is done via so-called identifiers, which are contained in each data packet and provide information about data content and the priority of the information. If several control units try to send information at the same time, the system checks which message has the highest priority. This message is sent first, the other messages follow in order of priority as soon as the bus is free again. The CAN bus can also detect faulty transmissions and repeat them accordingly.

The memory 18 of the control module 100 contains the implemented prediction function 16. The prediction function 16 is executed by the control module 100 to calculate a refill data set ads. In the refill data set ads, the control module 100 encodes a prediction of a refill requirement of one of the containers 10A, 10B, 10C. The control module 100 communicates the refill data set ads to a display device 19, such as a display screen.

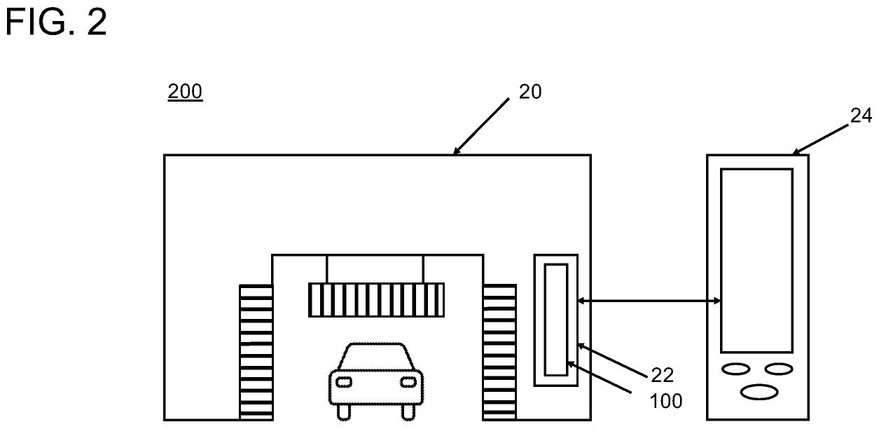

FIG. 2 shows in a schematic representation a system 200 according to the invention with a control module 100 and a washing system 20, which is symbolized in the schematic representation by a washing system terminal of a portal washing system. The control module 100 is part of a computing unit 22, and the computing unit 22 is installed at the terminal of the car wash 20. The computing unit 22 can communicate with an output device 24, which is shown here as a mobile terminal. In the present case, wireless communication takes place. The output on the mobile terminal may be provided in various ways. For example, acoustic, optical and/or haptic signals (vibration) or a combination thereof may be output.

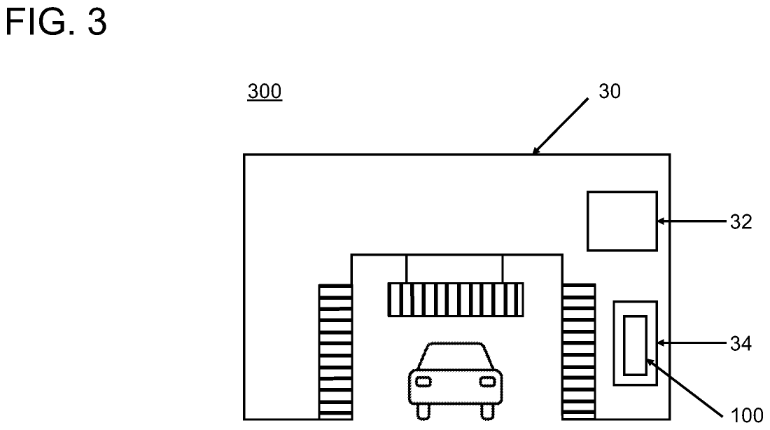

FIG. 3 illustrates an example of a further embodiment of a system according to the invention with a control module 100 and a washing system 30. In this example, the control module 100 is implemented in a stored program controller 34 at the washing system 30. Also, the output device, which is formed here as a display screen 32, is arranged at the washing system 30.

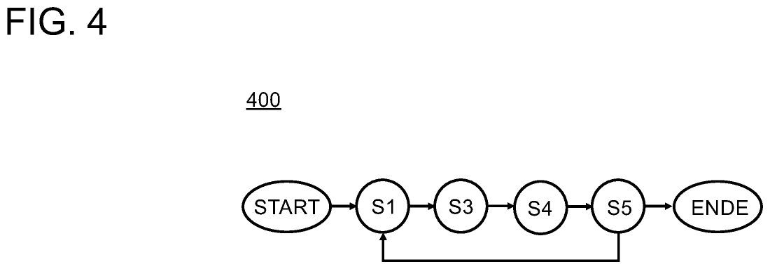

FIG. 4 shows an example of a flowchart for a method 400 according to the invention for predicting a refill requirement for washing substances. The method is executed by the control module 100 described above. When the method is executed (START), a sequence of steps may be executed, in particular steps S1 to S5 onwards. In a first step S1, the currently detected fill level data fsd are read in for each of the washing substances in the containers 10A, 10B, 100. The fill level data fsd are provided by the measuring devices 12A, 12B, 12C. The fill level data fsd are read in via the read-in interface 14 of the control module 100.

In step S3, the control module 100 executes the prediction function 16 stored in a memory 18 of the control module 100. The prediction function 16 is used to calculate the refill data set ads, in which a prediction of the refill requirement is end-coded, in step S4. The refill data set ads represents the refill requirement based on planning data, the planned vehicle washes at the car wash, and takes into account wash substance-specific consumption data and the recorded fill level data fsd.

In step S5, the method 400 provides for outputting the calculated refill data set to the output device 20 for predicting a wash substance-specific refill requirement. This may be done, for example, on the mobile terminal 24 of FIG. 2 or the screen 32 of FIG. 3. The method may end here or branch back to step S1 and be executed one or more further times there. In this embodiment example, only steps S1, S3 and S5 are executed.

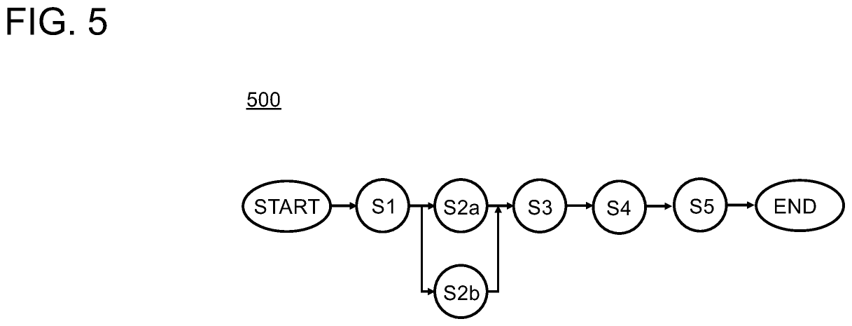

FIG. 5 is a second example of a flow diagram for a method 500 according to the invention for predicting a refill requirement for washing substances. Compared to the method 400, this method provides in particular at least one further step S2a. In step S2a, the fill levels in the storage containers are read in directly at the washing system 20,30. This can be done via a set of—sometimes different—fill level sensors. Cumulatively, a step S2b can be executed in which the fill levels in the respective storage containers are read in, which are not directly or not yet currently connected to the washing system 20, 30, but are located, for example, in a storage area.

In another embodiment not shown, a further step S1a may be performed. In step S1a, an identification device of the measuring device is used to identify one of the washing substances. For this purpose, a scanner may be formed, for example, which scans a digital code attached to the container for the washing substance.

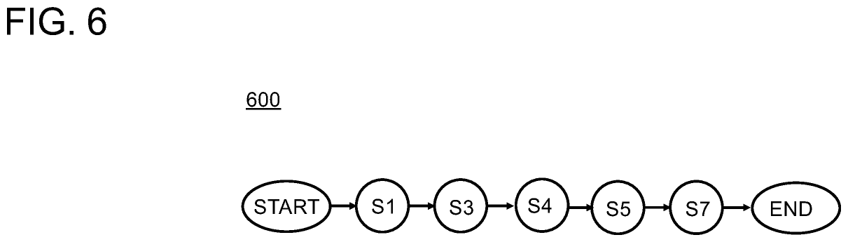

FIG. 6 is another example of a flow chart for a method according to the invention for predicting a refill requirement for washing substances. Compared to the method 400, this method in particular provides for a further step S7. In step S7, the control module 100 compares the calculated refill data set representing a refill requirement of a respective washing substance for the washing system with a reference value. The reference value is determined from forecasts and/or historical data of the washing system, in particular by means of averaging.

Methods 500 of FIGS. 5 and 600 of FIG. 6 can also be combined.

Finally, it should be noted that the description of the invention and the embodiments are in principle not to be understood restrictively with respect to any particular physical realization of the invention. All features explained and shown in connection with individual embodiments of the invention may be provided in different combinations in the subject matter according to the invention in order to simultaneously realize their advantageous effects.

The scope of protection of the present invention is given by the claims and is not limited by the features explained in the description or shown in the figures.

It is particularly obvious to a person skilled in the art that the invention can be applied not only to the sensor data mentioned, but also to other metrologically recorded variables from which a refilling requirement of the washing substances can be determined.

List of Reference Signs

100 Control module

10A, 10B, 10CB Vessel with washing substance

12A, 12B, 12C Measuring device

fsd Fill Level data

vds Consumption data

pds Planning data

ads refill data set

14 Read-in interface

16 Prediction function

18 Memory

19 Output device

200 System with a control module and a washing system

20 Car wash

22 Calculation unit

24 Output device

30 Car wash

32 Output device

34 Programmable logic controller

400, 500, 600 Method according to the invention

S1 to S7 Process steps

1. A method for predicting a refill requirement for washing substances for performing a vehicle wash by means of a washing system, comprising the following method steps:
reading in currently detected fill level data for each of the washing substances by means of a respective measuring device, the reading in being carried out via a read-in interface;
On a control module, executing a prediction function for calculating a refill data set, in which a prediction of the refill requirement is encoded, on the basis of planning data representing scheduled vehicle washes at the car wash, taking into account wash substance-specific consumption data and the acquired fill level data; and
outputting the calculated refill data set for predicting a wash substance-specific refill requirement on an output device.

2. The method of claim 1, wherein the measuring device is a fill level sensor that detects the level of the wash substance in a container.

3. The method according to claim 1, wherein the measuring device comprises or is in data exchange with an identification device, the identification device being arranged to identify the washing substance.

4. The method according to claim 3, wherein the identification device is a scanner that scans a digital code attached to the container for the washing substance.

5. The method according to claim 1, wherein reading in the fill level data comprises directly detecting the fill levels at the washing system and optionally indirectly detecting the fill levels in a storage area of the washing system.

6. The method according to claim 1, wherein the consumption data for one wash substance at a time is calculated from a sensed metering setting of a digital pump used to provide the respective wash substance.

7. The method according to claim 1, wherein consumption data from each or selected washes are aggregated.

8. The method according to claim 1, wherein the consumption data are calculated specifically for each washing plant.

9. The method according to claim 1, in which the control module matches the calculated refill data set representing a refill requirement of a respective washing substance for the washing system with a reference value determined from prediction data.

10. The method according to claim 1, wherein the calculated and output refill data set for predicting a refill requirement comprises an ascending alert, depending on a time interval to the upcoming refill requirement.

11. A control module for a car wash for performing a vehicle wash, the control module for providing a refill data set for predicting a refill requirement for wash substances, comprising:
at least one measuring device for acquiring current fill level data for each of the washing substances;
a data link between the at least one measuring device and the control module for transmitting the detected fill level data to the control module;
wherein the control module is designed to perform a prediction function for calculating a refill data set, in which a prediction of the refill requirement is encoded, on the basis of planning data representing scheduled vehicle washes at the car wash, taking into account wash substance-specific consumption data and the detected fill level data, and
an output device designed to output the refill data set calculated by the control module for predicting a wash substance-specific refill requirement.

12. A system for providing a refill data set for predicting a refill requirement for wash substances for a vehicle wash, comprising:
a control module according to claim 11, and
a car wash for carrying out the washing of the vehicle.

13. A computer program, the computer program being loadable into a memory unit of a computing unit and including program code portions for causing the computing unit to execute the method of predicting a refill requirement for wash substances for a wash system according to claim 1 when the computer program is executed in the computing unit.

14. The method according to claim 1, wherein average consumption values are determined from the collected consumption data.

15. The method according to claim 1, wherein the consumption data are correlated with washing plant-specific historical consumption data.

16. The method according to claim 1, wherein the consumption data are correlated with weather data.

17. The method according to claim 1, wherein the consumption data are correlated with holiday data.

18. The method according to claim 9, in which the control module matches the calculated refill data set representing a refill requirement of a respective washing substance for the washing system with a reference value determined from prediction data of the washing system by means of averaging.

19. The method according to claim 1, in which the control module matches the calculated refill data set representing a refill requirement of a respective washing substance for the washing system with a reference value determined from and/or historical data of the washing system.

20. The method according to claim 19, in which the control module matches the calculated refill data set representing a refill requirement of a respective washing substance for the washing system with a reference value determined from historical data of the washing system by means of averaging.
